(19) United States
(12) Patent Application Publication
(10) Pub. No.: US 2024/0191098 A1
(43) Pub. Date: Jun. 13, 2024

(54) EXTENSIBLE DECORATIVE FILM INCLUDING SURFACE LAYER HAVING SCRATCH RESISTANCE AND MATTE PROPERTIES AND SURFACE COATING COMPOSITION

(71) Applicant: 3M INNOVATIVE PROPERTIES COMPANY, St.Paul, MN (US)

(72) Inventor: Masakazu KINEBUCHI, Sagamihara (JP)

(21) Appl. No.: 18/556,386

(22) PCT Filed: Apr. 20, 2022
(86) PCT No.: PCT/IB2022/053708

§ 371 Date: Oct. 20, 2023

(30) Foreign Application Priority Data
Apr. 21, 2021 (JP) 2021-071930

(51) Int. Cl. C09D 175/04; C08J 7/046; C09D 5/16; C09D 7/40; C09D 7/61

(52) U.S. Cl. CPC C09D 175/04; C08J 7/046; C09D 5/1606; C09D 7/61; C09D 7/69; C08J 2375/04

(57) ABSTRACT

Provided is an extensible decorative film that includes a surface layer having excellent scratch resistance and matte properties before and after extension, and a surface coating composition that may form such a surface layer.

### TECHNICAL FIELD

The present disclosure relates to an extensible decorative film including a surface layer having scratch resistance and matte properties, and a surface coating composition.

### BACKGROUND

In recent years, decorative films having scratch resistance and matte properties have been developed. See, for example Patent Document 1 (JP 6255846 B) and Patent Document 2 (JP 6422433 B).

### SUMMARY

Decorative sheets are used, for example, in interior members having a three-dimensional shape, such as automobile instrument panel portions. When a decorative sheet is applied to such a member, the decorative sheet is generally applied to the member while being extended. Therefore, it has been difficult for a decorative sheet having scratch resistance and matte properties to maintain both the properties after extension.

The present disclosure provides an extensible decorative film that includes a surface layer having excellent scratch resistance and matte properties before and after extension, and a surface coating composition that may form such a surface layer.

An embodiment of the present disclosure provides an extensible decorative film including a substrate, and a surface layer containing inorganic particles having a mean particle diameter from approximately 15 micrometers to approximately 50 micrometers and a binder, having scratch resistance and matte properties, and disposed on the substrate, the surface layer containing approximately 35 parts by mass or greater of the inorganic particles based on 100 parts by mass of the binder.

Another embodiment of the present disclosure provides an article in which the extensible decorative film described above is adhered to a support member.

Still another embodiment of the present disclosure provides a method of producing an article having a three-dimensional shape, the method including applying the above extensible decorative film to a support member having a three-dimensional shape.

Still another embodiment of the present disclosure provides a surface coating composition containing inorganic particles having a mean particle diameter from 15 micrometers to 50 micrometers and a binder precursor, wherein the surface coating composition contains approximately 35 parts by mass or greater of the inorganic particles based on 100 parts by mass of the binder precursor.

### Advantageous Effects

According to the present disclosure, it is possible to provide an extensible decorative film that includes a surface layer having excellent scratch resistance and matte properties before and after extension, and a surface coating composition that may form such a surface layer.

The above description should not be construed as disclosing all embodiments or all advantages relating to the present disclosure.

### BRIEF DESCRIPTION OF DRAWINGS

FIG. 1 is a schematic cross-sectional view of an extensible decorative film according to an embodiment of the present disclosure.

FIG. 2 is a schematic cross-sectional view of an extensible decorative film according to another embodiment of the present disclosure.

### DESCRIPTION OF EMBODIMENTS

Hereinafter, representative embodiments of the present disclosure will be described in more detail with reference to the drawing as required for the purpose of illustration, but the present disclosure is not limited to these embodiments.

In the present disclosure, “matte properties” are intended to exhibit low surface glossiness compared to a surface layer that includes neither inorganic particles nor resin beads and can be intended to exhibit a surface glossiness at 60 degrees of 65.0 GU or less in the matte properties test described below.

In the present disclosure, “scratch resistance” is intended to be performance of being unlikely to be scratched and can be intended to exhibit a pencil hardness of 2B or greater in the pencil hardness test described below.

In the present disclosure, the term “(meth)acrylic” refers to acrylic or methacrylic, and the term “(meth)acrylate” refers to acrylate or methacrylate.

In the present disclosure, “curing” may also include a concept commonly referred to as “crosslink”.

In the present disclosure, the term “film” encompasses articles referred to as “sheets”.

In the present disclosure, the term “on”, for example used in “a surface layer is disposed on the substrate” means that the surface layer is disposed directly on the upper side of the substrate, or that the surface layer is indirectly disposed on the upper side of the substrate via other layers.

In the present disclosure, the term “under”, for example used in “an adhesive layer is disposed under the substrate” means that the adhesive layer is disposed directly under the lower side of the substrate, or that the adhesive layer is indirectly disposed under the lower side of the substrate via other layers.

In the present disclosure, “substantially” means that a variation caused by a manufacturing error or the like is included, and is intended to allow a variation of approximately ±20%.

In the present disclosure, “transparent” refers to an average transmittance in the visible light region (wavelength of 400 nm to 700 nm) measured in accordance with JIS K 7375 of approximately 80% or greater, and the average transmittance may be desirably approximately 85% or greater or approximately 90% or greater. The upper limit of the average transmittance is not particularly limited, and can be, for example, less than approximately 100%, approximately 99% or less, or approximately 98% or less.

In the present disclosure, “translucent” refers to an average transmittance in the visible light region (wavelength of 400 nm to 700 nm) measured in accordance with JIS K 7375 of less than approximately 80%, and the average transmittance may be desirably approximately 75% or less, and is intended not to completely hide an underlying layer.

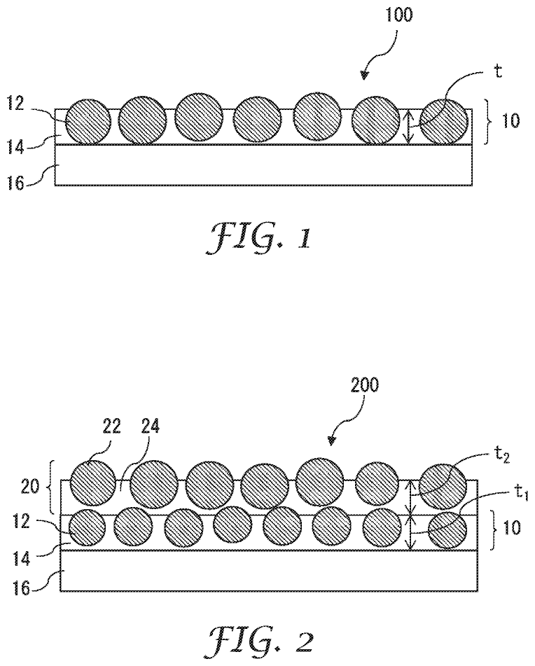

In an embodiment, an extensible decorative film according to the present disclosure (may be simply referred to as a “decorative film”) includes a substrate, and a surface layer containing inorganic particles having a mean particle diameter from approximately 15 micrometers to approximately 50 micrometers and a binder, having scratch resistance and matte properties, and disposed on the substrate, the surface layer containing approximately 35 parts by mass or greater of the inorganic particles based on 100 parts by mass of the binder. The surface layer may be in a single-layer structure as shown in FIG. 1 or may be in a layered structure as shown in FIG. 2.

When the inorganic particles are blended into the surface layer to develop scratch resistance, it is conceivable that inorganic particles having a small particle size, for example, are highly blended in the surface layer and the particles are densely disposed on the surface of the surface layer. However, in this case, since the surface roughness of the surface layer is low, it is difficult to develop an excellent matte effect. Additionally, small inorganic particles are highly blended in the surface layer. Thus, the surface layer tends to become brittle, and defects such as cracks or the like may occur in the surface layer during extension. In contrast, when inorganic particles having a large particle size are used, in terms of proportions of a portion where particles are present and of a portion in the surface of the surface layer where no particle is present in the surface of the surface layer, the proportion of the portion where particles are present tends to increase in comparison with the case where inorganic particles having a small particle size are used. This tendency is likely to be noticeable when the decorative film is extended, and thus it is difficult to maintain scratch resistance after extension.

The surface layer of the decorative film of the present disclosure contains approximately 35 parts by mass of the above-described inorganic particles having a relatively large mean particle diameter based on 100 parts by mass of the binder in the surface layer. As a result, the proportion of the portion where particles are not present in the surface of the surface layer can be reduced even after extension, Thus, a surface layer having both excellent scratch resistance and matte properties before and after extension can be obtained.

A schematic cross-sectional view of a decorative film of an embodiment of the present disclosure is shown in FIG. 1. A decorative film 100 of FIG. 1 includes a surface layer 10 and a substrate 16. The surface layer 10 includes inorganic particles 12 having a mean particle diameter from approximately 15 micrometers to approximately 50 micrometers and a binder 14.

The inorganic particles of the present disclosure can form fine convexities and concavities based on the inorganic particles 12 on the surface of the surface layer of the decorative film 100, as illustrated in FIG. 1, to form a suitable low gloss (matte) structure.

From the viewpoint of the matte properties and the scratch resistance, the mean particle diameter of the inorganic particles is preferably approximately more than 15 micrometers, approximately 16 micrometers or greater, approximately 18 micrometers or greater, approximately 20 micrometers or greater, approximately 23 micrometers or greater, approximately 25 micrometers or greater, and is preferably approximately 47 micrometers or less, approximately 45 micrometers or less, approximately 42 micrometers or less, approximately 40 micrometers or less, approximately 37 micrometers or less, or approximately 35 micrometers or less. The mean particle diameter of the inorganic particles is a particle size having a cumulative volume of 50% to be measured using a Cole counter method.

The inorganic particles are not particularly limited, and examples thereof include inorganic oxides, mixed oxide particles including two or more metal elements, or mixtures thereof. The inorganic oxide particles include, for example, at least one selected from the group consisting of alumina particles, tin oxide particles, antimony oxide particles, silica particles, zirconia particles, titania particles, and ferrite particles. The mixed oxide particles including two or more metal elements include, for example, mixed oxide particles including at least two metal elements selected from the group consisting of aluminum, tin, antimony; silicon, zirconium, titanium, and iron. The inorganic particles can be used alone or in combination of multiple types. Among these, from the viewpoint of the matte properties and scratch resistance, alumina particles are preferable.

The surface layer of the decorative film of the present disclosure contains approximately 35 parts by mass or greater of the inorganic particles based on 100 parts by mass of the binder. From the viewpoint of the matte properties and scratch resistance, the content of the inorganic particles is preferably approximately 37 parts by mass or greater, approximately 40 parts by mass or greater, approximately 42 parts by mass or greater, approximately 45 parts by mass or greater, approximately 47 parts by mass or greater, approximately 50 parts by mass or greater, approximately 52 parts by mass or greater, or approximately 55 parts by mass or greater. The upper limit of the content of the inorganic particles is not particularly limited and can be appropriately set in consideration of the manufacturing cost and desired performance, for example. From the viewpoint of the manufacturing costs, matte properties, scratch resistance, and fragility resistance of the surface layer, for example, the upper limit of the content of the inorganic particles may be approximately 200 parts by mass or less, approximately 150 parts by mass or less, approximately 100 parts by mass or less, approximately 80 parts by mass or less, approximately 75 parts by mass or less, approximately 70 parts by mass or less, or approximately 65 parts by mass or less.

Materials for the binder are not particularly limited, and it is possible to use, for example, a resin having a urethane bond, a (meth)acrylic resin, a vinyl chloride resin, a silicone resin, an epoxy resin, a fluororesin, a melamine resin, and an alkyd resin. Among these, a resin having a urethane bond is preferable. From the viewpoint of the scratch resistance, a non-adhesive and crosslinking-type resin is preferable. In the present disclosure, the term “resin having a urethane bond” may include, for example, a resin prepared using at least one type selected from urethane (meth)acrylate and urethane (meth)acrylate oligomer, and the urethane resin can also include a (meth)acrylic urethane resin, and the like. The binder can be used alone, or in combination of two or more. The “binder” in the present disclosure is intended to refer to a resin component other than the inorganic particles that constitutes the surface layer. Therefore, in the case where the optional component described below is a resin material, in addition to the resin material described above, the component is also considered as the binder component. To distinguish these, the resin material described above can be denoted by a “first binder component” and a resin material based on an optional component described below can be denoted by a “second binder component”.

The first binder component contains approximately 50 mass % or greater, approximately 60 mass % or greater, approximately 70 mass % or greater, approximately 75 mass % or greater, approximately 80 mass % or greater, or approximately 85 mass % or greater, and less than approximately 100 mass %, approximately 100 mass % or less, approximately 95 mass % or less, or approximately 90 mass % or less, based on the total amount of the binder.

The surface layer of the present disclosure may include, as optional components, additives such as an ultraviolet absorber, an antifoulant, a light stabilizer, a heat stabilizer, a dispersant, a plasticizer, a flow improver, a leveling agent, a pigment, a dye, and fragrance, for example. These additives can be used alone, or in combination of two or more types thereof. Each and the total contents of these additives can be decided in the range that does not impair the characteristics required for the surface layer.

The surface layer of the present disclosure may include particles other than the inorganic particles described above (e.g., organic particles such as resin beads, other inorganic particles having a smaller mean particle diameter than that of the inorganic particles described above, and metal particles or metal alloy particles) as long as the effects of the present disclosure are not affected. However, from the viewpoint of obtaining a surface layer having excellent scratch resistance and matte properties before and after extension, the content of such other particles in the surface layer is approximately 15 parts by mass or less, approximately 12 parts by mass or less, approximately 10 parts by mass or less, approximately 7 parts by mass or less, approximately 5 parts by mass or less, approximately less than 5 parts by mass, approximately 3 parts by mass or less, approximately 1 part by mass or less, or approximately 0.5 parts by mass or less based on 100 parts by mass of the binder, or more preferably, no such other particles are blended.

The inorganic particles of the present disclosure can form fine convexities and concavities based on the inorganic particles on the surface of the surface layer to form a suitable low gloss (matte) structure, as described above. The surface layer of the present disclosure has a fine convexity and concavity structure on the surface while exhibiting such low gloss, and therefore can additionally develop performance of making fouling, such as fingerprints, unlikely to adhere thereto or to be visible thereon (may be simply referred to as “antifouling properties”). For example, in applications requiring the antifouling performance, it is advantageous to blend an antifoulant in the surface layer in order to further improve the antifouling performance. The antifoulant is not particularly limited, and a silicone or fluorine antifoulant can be used, for example.

The surface coating composition of the present embodiment for forming a surface layer can contain various materials that can be used in the surface layer described above, contains at least inorganic particles having a mean particle diameter from approximately 15 micrometers to approximately 50 micrometers and a binder precursor, and contains approximately 35 parts by mass or greater of the inorganic particles based on 100 parts by mass of this binder precursor. Here, the “binder precursor” refers to a component that ultimately becomes a binder in the surface layer, and examples thereof include a curable or crosslinkable monomer and/or a curable or crosslinkable oligomer, a resin that is cured or crosslinked in advance, and a non-curable or non-crosslinkable resin such as a thermoplastic resin. Thus, the surface coating composition can contain additives such as a crosslinking agent and a curing agent, as optional components. A surface coating composition containing a crosslinking agent can be referred to as a crosslinking composition and a surface coating composition containing a curing agent can be referred to as a curable composition.

From the viewpoint of the matte properties and scratch resistance of the surface layer, the content of the inorganic particles in the surface coating composition is preferably approximately 37 parts by mass or greater, approximately 40 parts by mass or greater, approximately 42 parts by mass or greater, approximately 45 parts by mass or greater, approximately 47 parts by mass or greater, approximately 50 parts by mass or greater, approximately 52 parts by mass or greater, or approximately 55 parts by mass or greater based on 100 parts by mass of the binder precursor. The upper limit of the content of the inorganic particles is not particularly limited and can be appropriately set in consideration of the manufacturing cost and desired performance, for example. For example, from the viewpoint of manufacturing cost and the matte properties, scratch resistance, and fragility resistance of the surface layer, the upper limit of the content of inorganic particles can be approximately 200 parts by mass or less, approximately 150 parts by mass or less, approximately 100 parts by mass or less, approximately 80 parts by mass or less, approximately 75 parts by mass or less, approximately 70 parts by mass or less, or approximately 65 parts by mass or less.

The first binder component in the binder precursor can be approximately 50 mass % or greater, approximately 60 mass % or greater, approximately 70 mass % or greater, approximately 75 mass % or greater, approximately 80 mass % or greater, or approximately 85 mass % or greater, and approximately 100 mass % or less, approximately less than 100 mass %, approximately 95 mass % or less, or approximately 90 mass % or less based on the total amount of the binder precursor.

The various additives of the optional components described above can be appropriately blended within a range that does not impair the necessary characteristics of the surface layer obtained by the surface coating composition. In order to improve workability, coating properties, and the like, an organic solvent such as toluene, an aqueous dispersion medium, or the like can be optionally blended to the surface coating composition. As the aqueous dispersion medium, for example, distilled water, purified water, ion-exchanged water, and tap water can be used. In a range that does not affect the effect of the present disclosure, water soluble alcohols such as ethanol or the like may be used in combination with such water.

The method of forming a surface layer using the surface coating composition is not particularly limited, and a known method can be employed. The surface layer can be formed by coating the substrate with the surface coating composition using knife coating, bar coating, blade coating, doctor coating, roll coating, cast coating, and the like and, as necessary, drying and optionally thermosetting or ionizing radiation curing.

From the viewpoint of matte properties and scratch resistance, it is advantageous for the thickness of the surface layer to be the same as or smaller than the size of the mean particle diameter of the inorganic particles described above. With such a thickness, fine convexities and concavities based on the inorganic particles are easily formed on the surface of the surface layer. Specifically, the thickness of the surface layer can be, for example, approximately 5 micrometers or greater, approximately 8 micrometers or greater, approximately 10 micrometers or greater, approximately 13 micrometers or greater, approximately 15 micrometers or greater, approximately 17 micrometers or greater, approximately 20 micrometers or greater, approximately 23 micrometers or greater, approximately 25 micrometers or greater, approximately 27 micrometers or greater, or approximately 30 micrometers or greater and can be approximately 50 micrometers or less, approximately 45 micrometers or less, approximately 40 micrometer or less, approximately 35 micrometers or less, approximately 30 micrometers or less, approximately 25 micrometers or less, approximately 20 micrometers or less, or approximately 15 micrometers or less. The thickness of the surface layer can be appropriately selected based on the formability of convexities and concavities of the surface layer, and the required performance (for example, matte properties, scratch resistance) in accordance with the use application from such a range. Here, the thickness of the surface layer in the present disclosure is intended to be the point indicated by t in FIG. 1, that is, the distance from the bottom surface of the surface layer 10 to the bottommost portion in the recess of surface of the surface layer. The thickness of this surface layer is the average value of the thicknesses of at least any 5 points on the surface layer of the decorative film, obtained by measuring the cross section in the thickness direction of the decorative film using a scanning electron microscope.

The surface layer of the present disclosure may be in a layered structure. For example, as shown in FIG. 2, when the surface layer has a bilayer structure, the surface layer can be distinguished as a first surface layer 10 and a second surface layer 20. Similarly, the inorganic particles, the binder, and the thickness in the first surface layer 10 can be distinguished as first inorganic particles 12, a first binder 14, and a first thickness t₁, and the inorganic particles, the binder, and the thickness in the second surface layer 20 can be distinguished as second inorganic particles 22, a second binder 24, and a second thickness t₂. As for the types of inorganic particles, binders, and thicknesses in the first surface layer and the second surface layer, the above-mentioned ones can be each independently employed.

When the surface layer has a layered structure, the scratch resistance before and after extension can be further improved. For example, as shown in FIG. 2, when the mean particle diameter of the first inorganic particles 12 in the first surface layer 10 is made to be smaller than the mean particle diameter of the second inorganic particles 22 in the second surface layer 20, the second inorganic particles 22 are arranged on the first inorganic particles 12, which have hardness higher than that of the binder and are packed more densely than the second inorganic particles 22. As a result, the second inorganic particles 22 are supported by the first inorganic particles 12 having higher hardness than that of the binder positioned below, and thus, scratch resistance before and after extension can be further improved. In contrast, when a single surface layer is formed with a mixed solution obtained by mixing the first inorganic particles 12 and the second inorganic particles 22 different in the particle size, these particles are uniformly distributed in the layer, not forming the configuration as shown in FIG. 2. Thus, it is difficult to further improve the scratch resistance as in the layered structure.

The substrate constituting the decorative film of the present disclosure is not particularly limited, and for example, an organic substrate containing at least one selected from the group consisting of a polyvinyl chloride resin, a polyurethane resin, a polyolefin resin, a polyester resin, a vinyl chloride-vinyl acetate resin, a polycarbonate resin, a (meth)acrylic resin, a cellulose resin, and a fluororesin can be used.

The substrate exhibits a film shape and may be in a single-layer structure or a layered structure.

The substrate may be colored or colorless. In order to provide an intended appearance, the substrate may be opaque, semitransparent, or transparent entirely or partially in a visible area. The substrate may include a substantially smooth surface and may include a structured surface that can be formed by surface processing such as embossing.

In an embodiment, the substrate may include a transparent resin layer and a colored resin layer, for example, a transparent polyvinyl chloride resin layer and a colored polyvinyl chloride resin layer. In the decorative film of this embodiment, the colored resin layer is supported or protected by the transparent resin layer, and thus durability can be imparted to the decorative characteristics of the decorative film. For example, the decorative film of this embodiment can be used suitably for attaching to an interior article or an exterior article of a structure or a vehicle.

The thickness of the substrate can be approximately 25 micrometer or grater, approximately 50 micrometer or grater, or approximately 80 micrometer or grater, and can be approximately 5 mm or less, approximately 1 mm or less, and approximately 0.5 mm or less.

In some embodiments, a stretchable substrate layer can be used as the substrate. The tensile elongation ratio of the stretchable substrate can be approximately 10% or greater, approximately 20% or greater, or approximately 30% or greater, and can be approximately 400% or less, approximately 350% or less, or approximately 300% or less. The tensile elongation ratio of the stretchable substrate is a value calculated by preparing a sample having a width of 25 mm and a length of 150 mm and stretching the sample until the sample is broken using a tensile tester at a temperature of 20° C., a tensile test speed of 300 mm/min, and a grip spacing of 100 mm, using the equation: [grip spacing at the time of breaking (mm)−grip spacing before the stretching (mm) (=100 mm)]/grip spacing before the stretching (mm) (=100 mm)×100 (%).

In some embodiments, in the decorative film of this embodiment, additional layers such as a colored layer, a decorative layer, a bright layer, a bonding layer (primer layer), and an adhesive layer may be applied between the surface layer and the substrate, or on the substrate surface on the side opposite to the surface layer. These additional layers can be used alone or in combination of two or more types thereof, and can be applied to the entire surface or a part of the decorative film. The additional layers may have a three-dimensional shape such as an emboss pattern on a surface thereof.

A generally used adhesive such as a solvent-type, emulsion-type, pressure-sensitive type, heat-sensitive type, or heat-curable or radiation-curable type (for example, ultraviolet-curable type) adhesive, including acrylics, polyolefins, polyurethanes, polyesters, rubbers, and the like can be used as the adhesive layer. The thickness of the adhesive layer is not limited to the following and, for example, 5 micrometers or greater, approximately 10 micrometers or greater, or approximately 20 micrometers or greater, and can be approximately 100 micrometers or less, approximately 80 micrometers or less, or approximately 50 micrometers or less.

A release liner may be imparted to a surface of the adhesive layer. Examples of the release liner include paper: a plastic material such as polyethylene, polypropylene, polyester, and cellulose acetate: and paper coated with such a plastic material. These liners may have a surface subjected to peeling treatment with a peeling agent such as silicone or the like. The thickness of the release liner, generally, can be approximately 5 micrometers or greater, approximately 15 micrometers or greater, or approximately 25 micrometers or greater, and can be approximately 500 micrometers or less, approximately 300 micrometers or less, or approximately 250 micrometers or less.

The decorative film of the present disclosure may be a sheet-like article or a roll body wound in a roll shape.

The surface layer of the decorative film of the present disclosure has the matte properties. The matte properties can be evaluated, for example, with 60-degree surface glossiness, that is, a surface glossiness at 60 degrees. In some embodiments, the surface layer of the decorative film of the present disclosure exhibits a 60-degree surface glossiness of approximately 65.0 GU or less, approximately 60.0 GU or less, approximately 55.0 GU or less, approximately 50.0 GU or less, approximately 45.0 GU or less, approximately 40.0 GU or less, approximately 35.0 GU or less, approximately 30.0 GU or less, approximately 25.0 GU or less, approximately 20.0 GU or less, approximately 15.0 GU or less, approximately 10.0 GU or less, or approximately 5.0 GU or less at a point of low extension (e.g., maximum area extension percentage: 100%). The lower limit of the surface glossiness in this case is not particularly limited and, for example, can be approximately 0.1 GU or greater, approximately 0.5 GU or greater, or approximately 1.0 GU or greater. In some embodiments, the surface layer of the decorative film of the present disclosure exhibits a 60-degree surface glossiness of approximately 70.0 GU or less, approximately 65.0 GU or less, approximately 60.0 GU or less, approximately 55.0 GU or less, approximately 50.0 GU or less, approximately 45.0 GU or less, approximately 40.0 GU or less, approximately 35.0 GU or less, approximately 30.0 GU or less, approximately 25.0 GU or less, approximately 20.0 GU or less, or approximately 15.0 GU or less at a point of high extension (e.g., maximum area extension percentage: 200%). The lower limit of the surface glossiness in this case is not particularly limited: for example, it can be approximately 1.0 GU or greater, approximately 5.0 GU or greater, or approximately 10.0 GU or greater. The surface glossiness is a value measured using a portable glossmeter GMX-203 (Murakami Color Research Laboratory Co., Ltd., Chuo-ku, Tokyo, Japan).

The surface layer of the decorative film of the present disclosure has scratch resistance before and after extension. The scratch resistance can be evaluated with pencil hardness. In some embodiments, the surface layer of the decorative film of the present disclosure exhibits a pencil hardness of B or greater, HB or greater, H or greater, or 2H or greater at low extension (e.g., maximum area extension percentage: 100%). The upper limit of the pencil hardness in this case is not particularly limited: for example it can be 6H or less, 5H or less, or 4H or less. In some embodiments, the surface layer of the decorative film of the present disclosure exhibits a pencil hardness of 2B or greater, B or greater, HB or greater, or H or greater at a point of high extension (e.g., maximum area extension percentage: 200%). The upper limit of the pencil hardness in this case is not particularly limited: for example, it can be 4H or less, 3H or less, 2H or less, or H or less. The pencil hardness is a value determined by the pencil hardness test described below.

In some embodiments, the decorative film of the present disclosure has antifouling properties. The antifouling properties can be evaluated by pressing a finger against the surface layer of the decorative film and visually observing the presence or absence of a fingerprint. In the decorative film of the present disclosure of an embodiment, no fingerprint is observed on the surface layer of the decorative film after the test at a point of low extension (e.g., maximum area extension percentage: 100%) and a point of high extension (e.g., maximum area extension percentage: 200%).

According to an embodiment of the present disclosure, an article in which the decorative film mentioned above is bonded to a support member is provided. Examples of such an article may include a substantially flat article prior to molding processing, the substantially flat article being formed by adhering the decorative film to a support member, such as a polycarbonate plate: or an article having a three-dimensional shape obtained by further molding such a substantially flat article: or an article having a three-dimensional shape obtained by adhering the decorative film to a support member having a shape, such as a curved face. In the present disclosure, a “three-dimensional shape” is typically intended to be a three-dimensional shape in which the Z axis is added to a two-dimensional shape (a planar shape with only the X axis and the Y axis).

From the viewpoint of productivity and the like, the article having a three-dimensional shape is preferably produced by applying the decorative film described above to a support member having a three-dimensional shape. The application of the decorative film to the support member is preferably performed by means of vacuum molding or vacuum compressed air molding from the viewpoint of obtaining an article having high accuracy. Since the decorative film of the present disclosure exhibits excellent scratch resistance and matte properties even after extension, the decorative film can be suitably used for vacuum molding or vacuum compressed air molding with extension.

In a vacuum molding method and a vacuum compressed air molding method, the decorative film is generally exposed to heating and vacuum. The heating temperature may be approximately 50° C. or greater, approximately 80° C. or greater, approximately 100° C. or greater, approximately 120° C. or greater, or approximately 130° C. or greater, and may be approximately 180° C. or less, approximately 170° C. or less, or approximately 160° C. or less. The degree of vacuum of the vacuum atmosphere generally may be approximately 0.10 atm or less, approximately 0.05 atm or less, or approximately 0.01 atm or less, when atmospheric pressure is taken as 1 atm. The lower limit of the degree of vacuum is not particularly limited: for example, it can be approximately 0.0001 atm or greater, approximately 0.0005 atm or greater, approximately 0.001 atm or greater, or approximately 0.005 atm or greater. In the vacuum compressed air molding method, the decorative film is further exposed to pressure. The pressure can be, for example, greater than approximately 3 atm, approximately 4 atm or greater, or approximately 5 atm or greater when atmospheric pressure is taken as 1 atm. The upper limit of the pressure is not particularly limited but can be, for example, approximately 20 atm or lower, approximately 15 atm or lower, or approximately 10 atm or lower.

The maximum area extension percentage of the decorative film after molding may be generally approximately 50% or greater, approximately 100% or greater, approximately 150% or greater, or approximately 200% or greater, and approximately 1000% or less, approximately 500% or less, approximately 300% or less, or approximately 200% or less.

The area extension percentage is defined as area extension percentage (%)=(B−A)×100/A (where A is the area of a certain portion of the decorative film before molding, and B is the area of the portion corresponding to A of the decorative film after molding). For example, in a case where the area of a certain portion of the decorative film is 100 cm² before molding and the area of that portion on the surface of the support member after molding is 250 cm², it is 150%. The maximum area extension percentage means the value at the point of highest area extension percentage in the decorative film on the entire article surface.

For example, when a flat decorative film is bonded to a three-dimensional support member by a vacuum molding method, for example, the portion of the film that first affixes to the support member hardly expands and has an area extension percentage of nearly 0%, while the ends that are bonded last are expanded significantly and achieve an area extension percentage of 200% or greater. Thus, the area extension percentage of the decorative film varies widely depending on the location. Whether the molding is acceptable or not is determined by the presence or absence of defects such as nonconformity to the support member, tearing of the film, and the like in the portions of the film that are extended the most. Accordingly, the area extension percentage in the portion that was extended the most, that is, the maximum area extension percentage rather than the average area extension percentage of the overall article becomes the substantial index for the acceptability of the article to be finally obtained.

The maximum area extension percentage is determined by, for example, printing 1-mm squares on the entire surface of the decorative film before molding and then measuring the change in the areas thereof after molding, or by measuring the thickness of the decorative film before and after molding.

The material of the support member is not particularly limited, and is, for example, a polyurethane resin, a polyolefin resin (e.g., polyethylene and polypropylene), a glycol-modified polyethylene terephthalate resin (PET-G), a (meth)acrylic resin (e.g., a polymethylmethacrylate resin), a polycarbonate resin, and a acrylonitrile-butadiene-styrene copolymer (ABS). These components can be used alone, or in combination of two or more.

In order to provide an intended appearance, the support member may be transparent, semitransparent, or opaque entirely or partially in a visible area.

The thickness of the support member is not particularly limited and can be, for example, approximately 0.2 mm or greater, approximately 0.5 mm or greater, approximately 1.0 mm or greater, or approximately 1.5 mm or greater, and can be approximately 3.0 mm or less, approximately 2.5 mm or less, or approximately 2.0 mm or less.

Articles to which the decorative film of the present disclosure have been applied can be used in various applications. Example of such applications include signboards (e.g., internally illuminated signboards and externally illuminated signboards); signs (e.g., internally illuminated signs and externally illuminated signs); various interior products or exterior products, for example, interior products or exterior products for vehicles, such as automobiles, railways, aircrafts, and ships (e.g., roof members; pillar members; door trim members; instrument panel members; front members, such as hoods; bumper members; fender members; side sill members; and interior panel members); building members (e.g., doors); electric appliances such as personal computers, smartphones, mobile phones, refrigerators, and air conditioners; stationery; furniture; desks; and various containers such as cans. Among these, the article to which the decorative film of the present disclosure has been applied can be suitably used in interior articles or exterior articles for vehicles.

### EXAMPLES

In the following examples, specific embodiments of the present disclosure will be exemplified, but the present disclosure is not limited to those embodiments. All parts and percent are based on mass unless otherwise specified. A numerical value essentially includes an error derived from a measurement principle and a measuring device. The numerical value is generally indicated by a significant digit that is normally rounded.

Materials and reagents used in the present examples and comparative examples are indicated in Table 1.

TABLE 1

| | Trade name, | | |
|---|---|---|---|
| | model number or | | |
| Type | abbreviated name | Description | Available from |
| First binder | Nippolan (trade | Polyurethane resin, | Tosoh |
| component | name) 5196 | solid content: 30% | Corporation |
| Second binder | Megaface (trade | Fluorine type | DIC |
| component | name) F563 | antifoulant, solid | Corporation |
| | | content: 100% | |
| | Coronate (trade | Polyisocyanate | Tosoh |
| | name) HX | cross-linking agent, | Corporation |
| | | solid content: 100% | |
| Inorganic | ALUNABEADS | Alumina particles, | Showa Denko |
| particles | (trade name) | mean particle | K.K. |
| | CB-A20S | diameter: 20 μm, | |
| | | solid content: 100% | |
| | ALUNABEADS | Alumina particles, | Showa Denko |
| | (trade name) | mean particle | K.K. |
| | CB-A30S | diameter: 30 μm, | |
| | | solid content: 100% | |
| | ALUNABEADS | Alumina particles, | Showa Denko |
| | (trade name) | mean particle | K.K. |
| | CB-A40S | diameter: 40 μm, | |
| | | solid content: 100% | |
| | ALUNABEADS | Alumina particles, | Showa Denko |
| | (trade name) | mean particle | K.K. |
| | CB-A50S | diameter: 50 μm, | |
| | | solid content: 100% | |
| Substrate | FL AF1020 | Transparent acrylic | 3M Japan |
| | | film | Limited |

### Example 1: Surface Layer Single Layer Structure

A first surface coating composition was prepared by mixing 83.6 parts by mass of Nippolan (trade name) 5196, 2.4 parts by mass of Megaface (trade name) F563, 14.0 parts by mass of Coronate (trade name) HX, and 97.6 parts by mass of ALUNABEADS (trade name) CB-A30S, in terms of solid content, in a mixer. The first surface coating composition was applied onto a transparent acrylic film substrate (FL AF 1020) and then dried sequentially using ovens at 40° C., 65° C., 95° C., and 155° C. to produce a film including a first surface layer. Here, the dry application weight of the first surface layer was 0.47±0.03 g per 4 inches×6 inches, and the dry thickness of the first surface layer was approximately 30 micrometers.

Then, a polyurethane layer having a thickness of 20 micrometers and a thermoplastic acrylic adhesive layer colored in silver and having a thickness of 40 micrometers were sequentially bonded to the substrate side of the obtained film using a heat laminator at approximately 120° C. to produce a decorative film.

### Example 2: Surface Layer Bilayer Structure

A film including a first surface layer was produced in the same manner as in Example 1. Then, a second surface coating composition was prepared by mixing 83.6 parts by mass of Nippolan (trade name) 5196, 2.4 parts by mass of Megaface (trade name) F563, 14.0 parts by mass of Coronate (trade name) HX, and 97.6 parts by mass of ALUNABEADS (trade name) CB-A50S, in terms of solid content, in a mixer. This second surface coating composition was applied onto the first surface layer and then dried sequentially using ovens at 40° C., 65° C., 95° C., and 155° ° C. to produce a film including first and second surface layers. Here, the dry application weight of the second surface layer was 0.47±0.03 g per 4 inches×6 inches, and the dry thickness of the first surface layer was approximately 37 micrometers.

Then, a polyurethane layer and an adhesive layer colored in silver were sequentially bonded to the substrate side of the obtained film using a heat laminator at approximately 120° ° C. to produce a decorative film.

The characteristics of the decorative films of Examples 1 to 2 were evaluated by performing the following tests. The results are shown in Table 2.

### Physical Property Evaluation Tests

### (Three-Dimensional Moldability Test)

The decorative film obtained was bonded to a semi-cylindrical black support member (CK43, available from Techno-UMG Co., Ltd.) made of a polycarbonate resin and an ABS resin, using a DVT apparatus (available from Fu-se Vacuum Forming Ltd.), which is a vacuum compressed air molding apparatus, under molding conditions shown below. The surface of the decorative film in the bonded state was visually observed. Cases where defects such as wrinkles and matte failure did not occur were evaluated as “good”, and cases where such defects occurred were evaluated as “poor”:
Molding Conditions
Extension percentage (maximum area extension percentage): 180%
Set temperature at suction: 142° C.
Peak temperature of thermocouple sensor: 165° C.
Pressure molding delay time: 0.8 seconds

### (Pencil Hardness Test: Scratch Resistance)

The pencil hardness of the surface layer of the decorative film was measured in compliance with JIS K5600-5-4. Specifically, the decorative film was bonded to a substantially flat black support member (CK43, available from Techno-UMG Co., Ltd.) made of a polycarbonate resin and an ABS resin using a DVT apparatus (available from Fu-se Vacuum Forming Ltd.) under molding conditions shown below to produce a test sample. Then, with a load of 750 g applied to the tip of the pencil lead, the surface layer of the test sample was scratched by approximately 7 mm at a speed of 30 mm/min. This operation was performed at any 5 points on the surface layer. The maximum pencil hardness when the initial state without scratching was maintained at all the 5 points is shown in the table. As for the pencil hardness test, 2B or higher may be evaluated as an acceptable level:
Molding Conditions
Extension percentage (maximum area extension percentage): 100% or 200%
Set temperature at suction: 142° C.
Peak temperature of thermocouple sensor: 165° C.
Pressure molding delay time: 0.8 seconds

The decorative films of Examples 1 and 2 were produced using a coating apparatus, and decorative films of the other Examples and Comparative Examples were produced by hand coating. When the pencil hardnesses at 200% extension of the decorative films of Examples 1 and 6 having similar contents of inorganic particles are compared, the decorative film of Example 6 has a pencil hardness lower by two ranks. In a case where the film is produced also using the same coating apparatus as in Example 1, it can be predicted that the pencil hardness will increase by two ranks. Therefore, in Tables 3 and 4, converted values obtained by raising a pencil hardness by two ranks are shown so as to achieve the same results as in the case where each of the decorative films was produced using the same coating apparatus as in Example 1, and the measured values are shown in parentheses. The pass/fail judgment of the pencil hardnesses of the decorative films of Examples 3 to 14 and Comparative Examples 1 to 3 is determined with the converted values.

### (60-Degree Surface Glossiness Test: Matte Properties)

Test samples were made in the same manner as for the pencil hardness test samples. Then, the surface glossiness of the surface layer of each test sample was measured at a measurement angle of 60° using a portable glossmeter GMX-203 (available from Murakami Color Research Laboratory Co., Ltd.).

### (Test of Antifouling Properties)

Test samples were made in the same manner as for the pencil hardness test samples. Next, after a finger was pressed against the surface layer of the decorative film, the surface was visually observed. The case where no fingerprint was observed was evaluated as “good”, and the case where the fingerprint was observed was evaluated as “poor”.

TABLE 2

| | Extension | Example 1 | Example 2 |
|---|---|---|---|
| | percentage | (Surface layer | (Surface layer |
| Rating | (%) | single layer) | bilayer) |
| Three-dimensional | 180 | Good | Good |
| moldability | | | |
| Pencil hardness | 100 | 4H | 6H |
| | 200 | 2H | 3H |
| 60-degree surface | 100 | 0.8 | 14.4 |
| glossiness (GU) | 200 | 14.6 | 21.1 |
| Antifouling | 100 | Good | Good |
| properties | 200 | Good | Good |

### Example 3

A surface coating composition was prepared by mixing 83.7 parts by mass of Nippolan (trade name) 5196, 13.9 parts by mass of Megaface (trade name) F563, 2.4 parts by mass of Coronate (trade name) HX, and 106.5 parts by mass of ALUNABEADS (trade name) CB-A20S, in terms of solid content, in a mixer. After this surface coating composition was hand-coated onto a transparent acrylic film substrate (FL AF1020) using a notch bar coater to a thickness of approximately 35 micrometers, the composition was dried in an oven at approximately 65° C. for approximately 2 minutes, in an oven at approximately 80° C. for approximately 3 minutes, and in an oven at approximately 155° C. for approximately 2 minutes to thereby produce a film including a surface layer. The dry thickness of the surface layer here was approximately 30 micrometers.

Then, a polyurethane layer having a thickness of 20 micrometers and a thermoplastic acrylic adhesive layer colored in silver and having a thickness of 40 micrometers were sequentially bonded to the substrate side of the obtained film using a heat laminator at approximately 120° ° C. to produce a decorative film.

### Examples 4 to 5 and Comparative Example 1

A decorative film of each of Examples 4 to 5 and Comparative Example 1 was produced in the same manner as in Example 3 except that the amount of ALUNABEADS (trade name) CB-A20S blended was changed to each of the amounts blended listed in Table 3.

### Examples 6 to 8 and Comparative Example 2

A decorative film of each of Examples 6 to 8 and Comparative Example 2 was produced in the same manner as in Example 3 except that ALUNABEADS (trade name) CB-A30S was employed as the inorganic particles and the amount thereof blended was changed to each of the amounts blended listed in Table 3.

### Examples 9 to 11

A decorative film of each of Examples 9 to 11 was produced in the same manner as in Example 3 except that ALUNABEADS (trade name) CB-A40S was employed as the inorganic particles and the amount thereof blended was changed to each of the amounts blended listed in Table 4.

### Examples 12 to 14 and Comparative Example 3

A decorative film of each of Examples 12 to 14 and Comparative Example 3 was produced in the same manner as in Example 3 except that ALUNABEADS (trade name) CB-A50S was employed as the inorganic particles and the amount thereof blended was changed to each of the amounts blended listed in Table 4.

The characteristics of the decorative films of Examples 3 to 14 and Comparative Examples 1 to 3 were evaluated by performing the tests described above. The results are shown in Tables 3 to 4.

TABLE 3

| | | Example | Example | Example | Comparative | Example | Example | Example | Comparative |
|---|---|---|---|---|---|---|---|---|---|
| | | 3 | 4 | 5 | Example 1 | 6 | 7 | 8 | Example 2 |
| Mean particle diameter (μm) | | 20 | 20 | 20 | 20 | 30 | 30 | 30 | 30 |
| Particle content (parts by mass) | | 106.5 | 64.9 | 48.8 | 30.1 | 106.5 | 64.9 | 48.8 | 30.1 |
| Rating | Extension | | | | | | | | |
| | percentage (%) | | | | | | | | |
| Three-dimensional | 180 | Good | Good | Good | Good | Good | Good | Good | Good |
| moldability | | | | | | | | | |
| Pencil hardness | 100 | 4H (2H) | 4H (2H) | H (B) | B (3B) | 6H (4H) | 6H (4H) | 5H (3H) | 2H (HB) |
| | 200 | 2H (HB) | 2H (HB) | HB (2B) | 3B (5B) | 2H (HB) | 2H (HB) | 2H (HB) | 3B (5B) |
| 60-degree surface | 100 | 14.6 | 14.4 | 20.5 | 55.7 | 16.8 | 32.3 | 34.2 | 55.7 |
| glossiness (GU) | 200 | 19.6 | 22.2 | 27.5 | 64.7 | 27.7 | 41.9 | 46.2 | 63.4 |
| Antifouling | 100 | Good | Good | Good | Good | Good | Good | Good | Good |
| properties | 200 | Good | Good | Good | Good | Good | Good | Good | Good |

TABLE 4

| | | Example | Example | Example | Example | Example | Example | Comparative |
|---|---|---|---|---|---|---|---|---|
| | | 9 | 10 | 11 | 12 | 13 | 14 | Example 3 |
| Mean particle diameter (μm) | | 40 | 40 | 40 | 50 | 50 | 50 | 50 |
| Particle content (parts by mass) | | 106.5 | 64.9 | 48.8 | 106.5 | 64.9 | 48.8 | 30.1 |
| Rating | Extension | | | | | | | |
| | percentage (%) | | | | | | | |
| Three-dimensional | 180 | Good | Good | Good | Good | Good | Good | Good |
| moldability | | | | | | | | |
| Pencil hardness | 100 | 6H (4H) | 5H (3H) | 5H (3H) | 2H (HB) | 2H (HB) | H (B) | 2B (4B) |
| | 200 | 2H (HB) | H (B) | H (B) | B (3B) | B (3B) | 2B (4B) | 3B (5B) |
| 60-degree surface | 100 | 19.6 | 25.3 | 30.4 | 43.4 | 44.7 | 61.4 | 71.1 |
| glossiness (GU) | 200 | 29.6 | 33.7 | 38.9 | 58.9 | 61.8 | 69.9 | 82.6 |
| Antifouling | 100 | Good | Good | Good | Good | Good | Good | Good |
| properties | 200 | Good | Good | Good | Good | Good | Good | Good |

Various variations of the above embodiments and examples will be apparent to those skilled in the art without departing from the basic principles disclosed herein. In addition, various modifications and variations will be apparent to those skilled in the art without departing from the spirit and scope of the present disclosure.

### REFERENCE SIGNS LIST

10 Surface layer (first surface layer)
12 Inorganic particle (first inorganic particle)
14 Binder (first binder)
16 Substrate
20 Surface layer (second surface layer)
22 Inorganic particle (second inorganic particle)
24 Binder (second binder)
100, 200 Decorative film
t Thickness of surface layer
t₁ Thickness of first surface layer
t₂ Thickness of second surface layer

1. An extensible decorative film, comprising:
a substrate, and
a surface layer containing inorganic particles having a mean particle diameter from 15 micrometers to 50 micrometers and a binder, having scratch resistance and matte properties, and being disposed on the substrate,
the surface layer containing 35 parts by mass or greater of the inorganic particles based on 100 parts by mass of the binder.

2. The film according to claim 1, wherein the surface layer has a 60-degree surface glossiness of 70.0 GU or less at a point of maximum area extension percentage of 200%.

3. The film according to claim 1, wherein the surface layer exhibits a pencil hardness of 2B or greater at a point of maximum area extension percentage of 200%.

4. The film according to claim 1, wherein the surface layer has a thickness equal to or smaller than the mean particle diameter of the inorganic particles.

5. The film according to claim 1, wherein the binder comprises at least one selected from resins having a urethane bond, (meth)acrylic resins, vinyl chloride resins, silicone resins, epoxy resins, fluororesins, melamine resins, and alkyd resins.

6. The film of claim 1, wherein the inorganic particles include at least one of inorganic oxide particles selected from the group consisting of alumina particles, tin oxide particles, antimony oxide particles, silica particles, zirconia particles, titania particles, and ferrite particles, mixed oxide particles comprising at least two metal elements selected from the group consisting of aluminum, tin, antimony, silicon, zirconium, titanium, and iron, or mixtures thereof.

7. The film according to claim 1, wherein the surface layer has a layered structure.

8. The film according to claim 1, wherein the surface layer further comprises an antifoulant.

9. The film according to claim 1, which is used for vacuum molding or vacuum compressed air molding.

10. An article comprising the film described in claim 1, the film being bonded to a support member.

11. The article according to claim 10, which has a three-dimensional shape.

12. The article according to claim 10, which is an interior article or exterior article of a vehicle.

13. A method of producing an article having a three-dimensional shape, comprising applying the film according to claim 1 to a support member having a three-dimensional shape.

14. The method according to claim 13, wherein the application of the film to the support member is performed by vacuum molding or vacuum compressed air molding.

15. A surface coating composition comprising: inorganic particles having a mean particle diameter from 15 micrometers to 50 micrometers, and a binder precursor, wherein
the surface coating composition contains 35 parts by mass or greater of the inorganic particles based on 100 parts by mass of the binder precursor.
